(19) United States
(12) Patent Application Publication
(10) Pub. No.: US 2023/0319716 A1
(43) Pub. Date: Oct. 5, 2023

(54) RADIO FREQUENCY BAND SCANNING FOR MULTIPLE SUBSCRIBER IDENTIFICATION MODULES

(71) Applicant: QUALCOMM Incorporated, San Diego, CA (US)

(72) Inventors: Ansah Ahmed SHEIK, Hyderabad (IN); Daniel AMERGA, San Diego, CA (US); Sayak SAHA, San Diego, CA (US); Rajeev KUMAR, Bangalore (IN)

(21) Appl. No.: 18/042,449

(22) PCT Filed: May 7, 2021
(86) PCT No.: PCT/US2021/031336

§ 371 Date: Feb. 21, 2023

(30) Foreign Application Priority Data
Oct. 7, 2020 (IN) 202041043641

(51) Int. Cl. H04W 52/02; H04W 48/16

(52) U.S. Cl. CPC H04W 52/0229; H04W 48/16; H04W 88/06

(57) ABSTRACT

Methods, systems, and devices for wireless communications are described. A user equipment (UE) may perform a first scan procedure for a first of radio frequency bands according to a default scanning order at a first subscription of the UE, store an indication of a subset of radio frequency bands of the first set of radio frequency bands for the first scan procedure, and perform a second scan procedure for a second set of radio frequency bands according to a modified scanning order based on the stored indication of the subset of radio frequency bands. In some cases, the UE may determine a relevance of the stored indication of the subset of radio frequency bands of the first set of radio frequency bands and determine the modified scanning order based on the relevance of the stored indication.

### CROSS REFERENCE

The present Application is a 371 national stage filing of International PCT Application No. PCT/US2021/031336 by SHEIK et al. entitled “RADIO FREQUENCY BAND SCANNING FOR MULTIPLE SUBSCRIBER IDENTIFICATION MODULES,” filed May 7, 2021; and claims priority to India Provisional Patent Application No. 202041043641 by SHEIK et al., entitled “RADIO FREQUENCY BAND SCANNING FOR MULTIPLE SUBSCRIBER IDENTIFICATION MODULES,” filed Oct. 7, 2020, each of which is assigned to the assignee hereof, and each of which is expressly incorporated by reference in its entirety herein.

### FIELD OF TECHNOLOGY

The following relates to wireless communications, including radio frequency band scanning for multiple subscriber identification modules (SIMs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some cases, a UE may be configured with multiple subscriptions or multiple subscriber identity modules (SIMs), and the UE may perform multiple scan procedures corresponding to the multiple subscriptions or SIMS. However, the UE may perform redundant frequency band scans, which may decrease battery life and degrade user experience.

### SUMMARY

The described techniques relate to improved methods, systems, devices, and apparatuses that support radio frequency band scanning for multiple subscriber identification modules (SIMs). Generally, the described techniques provide for reducing signal acquisition time, increasing battery life, and enhancing user experience. For example, a user equipment (UE) may use band scan information from a first scan procedure to improve the speed of a second scan procedure.

For example, the UE may perform a first scan procedure for a first set of radio frequency bands according to a default scanning order at a first subscription of the UE, store an indication of a subset of radio frequency bands of the first set of radio frequency bands for the first scan procedure, and perform a second scan procedure for a second set of radio frequency bands according to a modified scanning order based on the stored indication of the subset of radio frequency bands. In some cases, the UE may determine a relevance of the stored indication of the subset of radio frequency bands of the first set of radio frequency bands and determine the modified scanning order based on the relevance of the stored indication.

A method of wireless communication at a UE is described. The method may include performing, at a first subscription of the UE, a first scan procedure for a first set of radio frequency bands according to a default scanning order, storing an indication of a subset of radio frequency bands of the first set of radio frequency bands for the first scan procedure, and performing a second scan procedure for a second set of radio frequency bands according to a modified scanning order based on the stored indication of the subset of radio frequency bands.

An apparatus for wireless communication at a UE is described. The apparatus may include a processor, memory coupled with the processor, and instructions stored in the memory. The instructions may be executable by the processor to cause the apparatus to perform, at a first subscription of the UE, a first scan procedure for a first set of radio frequency bands according to a default scanning order, store an indication of a subset of radio frequency bands of the first set of radio frequency bands for the first scan procedure, and perform a second scan procedure for a second set of radio frequency bands according to a modified scanning order based on the stored indication of the subset of radio frequency bands.

Another apparatus for wireless communication at a UE is described. The apparatus may include means for performing, at a first subscription of the UE, a first scan procedure for a first set of radio frequency bands according to a default scanning order, storing an indication of a subset of radio frequency bands of the first set of radio frequency bands for the first scan procedure, and performing a second scan procedure for a second set of radio frequency bands according to a modified scanning order based on the stored indication of the subset of radio frequency bands.

A non-transitory computer-readable medium storing code for wireless communication at a UE is described. The code may include instructions executable by a processor to perform, at a first subscription of the UE, a first scan procedure for a first set of radio frequency bands according to a default scanning order, store an indication of a subset of radio frequency bands of the first set of radio frequency bands for the first scan procedure, and perform a second scan procedure for a second set of radio frequency bands according to a modified scanning order based on the stored indication of the subset of radio frequency bands.

In some examples of the method, apparatuses, and non-transitory computer-readable medium described herein, performing the second scan procedure may include operations, features, means, or instructions for determining a relevance of the stored indication of the subset of radio frequency bands of the first set of radio frequency bands, and determining the modified scanning order based on the relevance of the stored indication.

In some examples of the method, apparatuses, and non-transitory computer-readable medium described herein, determining the relevance of the stored indication of the subset of radio frequency bands of the first set of radio frequency bands may include operations, features, means, or instructions for identifying a time difference between the first scan procedure and the second scan procedure, a location of the first scan procedure and a location of the second scan procedure, or a combination thereof.

In some examples of the method, apparatuses, and non-transitory computer-readable medium described herein, performing the second scan procedure may include operations, features, means, or instructions for determining that the second scan procedure starts within a first time threshold from an end of the first scan procedure, and skipping the subset of radio frequency bands of the first set of radio frequency bands based on the indication of the subset of radio frequency bands.

In some examples of the method, apparatuses, and non-transitory computer-readable medium described herein, performing the second scan procedure may include operations, features, means, or instructions for determining that the second scan procedure starts within a second time threshold from an end of the first scan procedure, and determining the modified scanning order by prioritizing scanning of radio frequency bands of the second set of radio frequency bands that may be different than the subset of radio frequency bands of the first set of radio frequency bands based on the indication of the subset of radio frequency bands.

Some examples of the method, apparatuses, and non-transitory computer-readable medium described herein may further include operations, features, means, or instructions for configuring a first timer length for a first timer and a second timer length for a second timer, where the first timer length may be shorter than the second timer length.

In some examples of the method, apparatuses, and non-transitory computer-readable medium described herein, determining that the second scan procedure starts within a first time threshold may include operations, features, means, or instructions for determining that the first timer may be active.

In some examples of the method, apparatuses, and non-transitory computer-readable medium described herein, determining that the second scan procedure starts within the second time threshold may include operations, features, means, or instructions for determining that the second timer may be active.

Some examples of the method, apparatuses, and non-transitory computer-readable medium described herein may further include operations, features, means, or instructions for activating a first timer and performing the second scan procedure based on activating the first timer.

In some examples of the method, apparatuses, and non-transitory computer-readable medium described herein, the subset of radio frequency bands of the first set of radio frequency bands corresponds radio frequency bands scanned during the first scan procedure.

Some examples of the method, apparatuses, and non-transitory computer-readable medium described herein may further include operations, features, means, or instructions for camping on a first radio frequency of the first set of radio frequency bands based on the first scan procedure, and camping on the first radio frequency of the second set of radio frequency bands based on the second scan procedure.

Some examples of the method, apparatuses, and non-transitory computer-readable medium described herein may further include operations, features, means, or instructions for determining that the second scan procedure may have completed based on satisfying a time threshold, and removing the indication of the subset of radio frequency bands of the first set of radio frequency bands based on determining that the second scan procedure may have completed.

### BRIEF DESCRIPTION OF THE DRAWINGS

FIG. 1 illustrates an example of a system for wireless communications that supports radio frequency band scanning for multiple subscriber identification modules (SIMS) in accordance with aspects of the present disclosure.

FIG. 2 illustrates an example of a wireless communication system that supports radio frequency band scanning for multiple SIMs in accordance with aspects of the present disclosure.

FIG. 3 illustrates an example of a flowchart that supports radio frequency band scanning for multiple SIMS in accordance with aspects of the present disclosure.

FIG. 4 illustrates an example of a band scan technique that supports radio frequency band scanning for multiple SIMs in accordance with aspects of the present disclosure.

FIG. 5 illustrates an example of a band scan technique that supports radio frequency band scanning for multiple SIMs in accordance with aspects of the present disclosure.

FIG. 6 illustrates an example of a process flow that supports radio frequency band scanning for multiple SIMS in accordance with aspects of the present disclosure.

FIGS. 7 and 8 show block diagrams of devices that support radio frequency band scanning for multiple SIMS in accordance with aspects of the present disclosure.

FIG. 9 shows a block diagram of a communications manager that supports radio frequency band scanning for multiple SIMs in accordance with aspects of the present disclosure.

FIG. 10 shows a diagram of a system including a device that supports radio frequency band scanning for multiple SIMs in accordance with aspects of the present disclosure.

FIGS. 11 and 12 show flowcharts illustrating methods that support radio frequency band scanning for multiple SIMS in accordance with aspects of the present disclosure.

### DETAILED DESCRIPTION

In some wireless communications systems, a user equipment (UE) may be configured with multiple data subscriptions corresponding to multiple subscriber identification modules (SIMs). In some cases, the multiple data subscriptions may be configured to operate on one or more of the same or overlapping radio frequency bands, and the UE may scan the one or more frequency bands as part of multiple scan procedures. For example, the UE may perform a first scan procedure for a first data subscription and a second scan procedure for a second data subscription, and the UE may scan the same one or more frequency bands in both the first scan procedure and the second scan procedure. In some cases, the UE may perform the multiple scan procedures following a power up procedure and/or a radio link failure (RLF). In some cases, the UE may scan the same frequency bands as part of multiple scan procedures, and the UE may scan the same frequency bands in the same order (e.g., the same sequence of frequency bands) as part of multiple scan procedures. However, scanning the same sequence of frequency bands as part of multiple scan procedures may be redundant, inefficient, and increase service acquisition time.

Various aspects of the present disclosure provide techniques for performing band scan procedures in the context of multiple data subscriptions or multiple SIMs. In some cases, a UE may modify a second frequency band scan procedure (e.g., for the same subscription or for a second subscription) based on a first scan procedure for a first subscription. For example, the UE may scan frequency bands of the first subscription as part of the first scan procedure, and the UE may modify a scanning order of frequency bands (e.g., by skipping or deprioritizing) of the second subscription that are scanned as part of the first scan procedure. The UE may modify (e.g., skip one or more frequency bands, deprioritize one or more frequency bands, prioritize one or more frequency bands) the second scan procedure based on frequency bands that were scanned as part of the first scan procedure to avoid redundant band scans, which may increase battery life and decrease service acquisition time.

Such techniques may include performing a first scan procedure for a first set of radio frequency bands at a first subscription according to a default scanning order, storing an indication of a subset of radio frequency bands of the first set of radio frequency bands for the first scan procedure, and performing a second scan procedure for a second set of radio frequency bands according to a modified scanning order based on the stored indication of the subset of radio frequency bands. The second scan procedure may correspond to a subsequent scan procedure for the first subscription or a scan procedure for a second subscription. The techniques may additionally include determining a relevance of the stored indication of the subset of radio frequency bands of the first set of radio frequency bands and determining the modified scanning order based on the relevance of the stored indication. In some cases, the relevance may be determined based on a time difference between the first scan procedure and the second scan procedure and/or a location of the first scan procedure and a location of the second scan procedure (e.g., a geographic location, a network area location, or cell location of the UE during the first and second scan procedures). For example, a shorter time difference may be associated with higher relevance and a longer time difference may be associated with lower relevance. The modified scanning order may be based on skipping one or more frequency bands (e.g., the bands that were scanned as part of the first scan procedure) and/or deprioritizing one or more frequency bands such that unique frequency bands are scanned before frequency bands that were already scanned.

Aspects of the disclosure are initially described in the context of wireless communications systems. Aspects of the disclosure are then described in the context of a flowchart, band scan techniques, and a process flow. Aspects of the disclosure are further illustrated by and described with reference to apparatus diagrams, system diagrams, and flowcharts that relate to radio frequency band scanning for multiple SIMs.

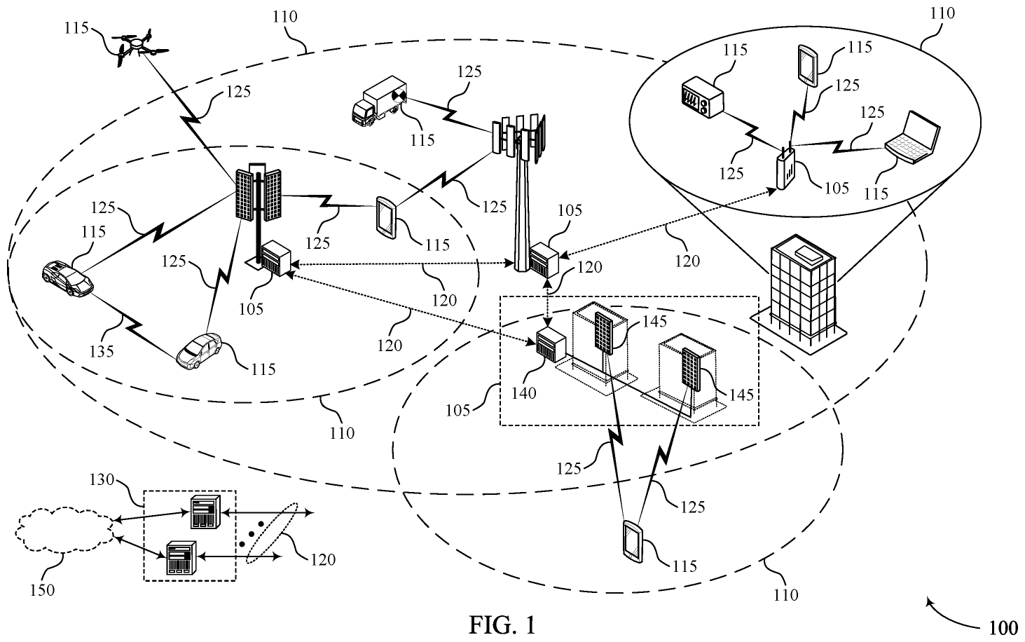

FIG. 1 illustrates an example of a wireless communications system 100 that supports radio frequency band scanning for multiple SIMs in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f})) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may perform a first scan procedure for a first set of radio frequency bands according to a default scanning order at a first subscription of the UE 115, store an indication of a subset of radio frequency bands of the first set of radio frequency bands for the first scan procedure, and perform a second scan procedure for a second set of radio frequency bands according to a modified scanning order based on the stored indication of the subset of radio frequency bands. In some cases, the UE 115 may determine a relevance of the stored indication of the subset of radio frequency bands of the first set of radio frequency bands and determine the modified scanning order based on the relevance of the stored indication.

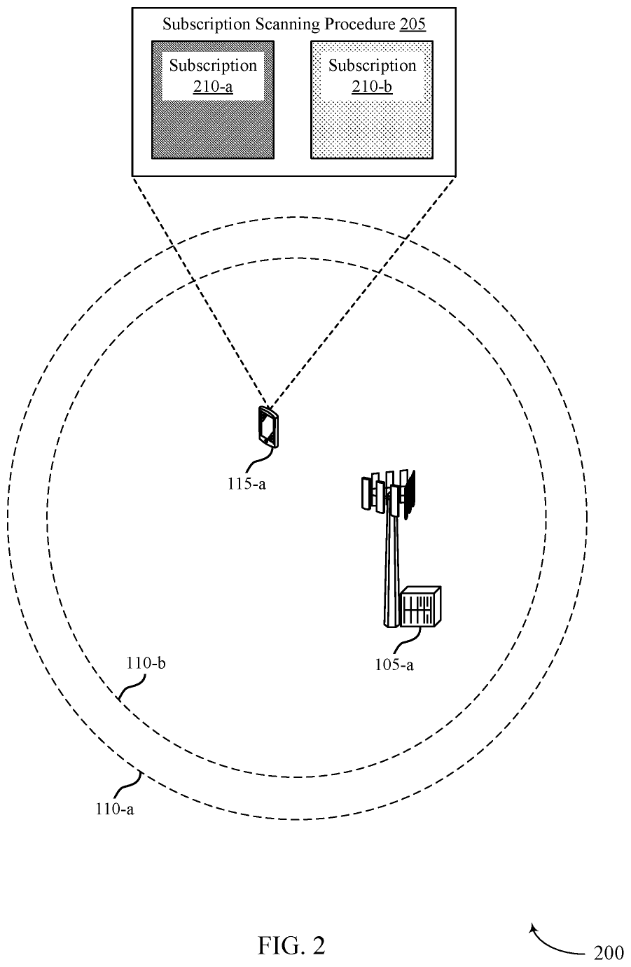

FIG. 2 illustrates an example of a wireless communications 200 that supports radio frequency band scanning for multiple SIMs in accordance with aspects of the present disclosure. In some examples, the wireless communications 200 may implement aspects of wireless communication system 100. The wireless communications system 200 may include base station 105-a and UE 115-a, which may be examples of a base station 105 and UE 115, respectively, as described with reference to FIG. 1. Base station 105-a may be associated with coverage area 110-a and coverage area 110-b, and UE 115-a may be configured for communication with base stations 105-a. In some examples, UE 115-a may be configured with multiple subscriptions (e.g., multiple SIMs, dual-SIM, multi-SIM, etc.) and communicate with one or more base stations 105 via multiple cells.

In some cases, UE 115-a may be associated with multiple subscriptions (e.g., multiple SIMS) and perform a band scan procedure for each of the multiple subscriptions. For example, UE 115-a may be associated with subscription 210-a (e.g., a first subscription, a first SIM) and subscription 210-b (a second subscription, a second SIM). UE 115-a may perform a subscription scanning procedure 205, which may reduce power usage, increase battery life, and improve user experience. For example, the subscription scanning procedure 205 may reduce the number of bands scanned by UE 115-a and increase the efficiency of one or more band scan procedures.

As part of the subscription scanning procedure 205, UE 115-a may store an indication of frequency bands that are scanned during a first band scan procedure corresponding to a first subscription (e.g., subscription 210-a) and use the indication of the frequency bands to skip, deprioritize, or otherwise reorder the frequency bands for a second band scan procedure corresponding to the subscription 210-a or a second subscription (e.g., subscription 210-b). In some cases, subscription 210-a and subscription 210-b may correspond to the same subscription (e.g., the same SIM), while in some other cases, subscription 210-a and subscription 210-b may correspond to different subscriptions (e.g., different SIMs).

In some cases, as part of the subscription scanning procedure 205, UE 115-a may determine a relevance of a scan procedure, or of one or more frequency bands of the scan procedure, and use the determined relevance to skip, deprioritize, or otherwise reorder frequency bands for an additional band scan procedure. For example, UE 115-a may skip frequency bands during a second band scan procedure that were scanned during a first band scan procedure if stored information corresponding to the frequency bands is determined to be relevant (e.g., having a relevance metric above a threshold because the frequency bands were recently scanned and/or the UE is in the same location). As another example, UE 115-a may deprioritize frequency bands during the second band scan procedure that were scanned during the first band scan procedure if stored information corresponding to the frequency bands is determined to be less relevant (e.g., having a relevance metric below a threshold because a threshold time has passed since the first band scan procedure and/or the UE has moved since the first band scan procedure). UE 115-a may use one or more procedures or methodologies for determining band relevance that encompass a variety of conditions and metrics. The determined relevance may support flexible and robust band scan techniques that improve battery life and user experience.

In some cases, UE 115-a may determine the relevance of stored band information from a first band scan procedure based on one or more timers. For example, one or more timers may be used to determine how much time has elapsed since a first band scan procedure. In some examples, less elapsed time may correspond to higher relevance and more elapsed time may correspond to lower relevance. A timer may be configurated (e.g., a time duration configuration, a time threshold configuration, etc.) statically or dynamically. As a non-limiting example, UE 115-a may start a timer and store an indication of bands scanned as part of the first band scan procedure for subscription 210-a and skip or deprioritize one or more bands as part of a second band scan procedure for subscription 210-b based on the stored indication of the bands and the timer indicating an amount of elapsed time. The timer may be started based on completion of a band scan procedure, expiration of a second timer, or an amount of elapsed time since starting the second timer. In some examples, UE 115-a may skip the one or more frequency bands as part of the second band scan procedure for subscription 210-b (or subscription 210-a) based on a timer threshold not being satisfied (e.g., less than a threshold amount of time has elapsed), and in some additional or alternative examples, UE 115-a may deprioritize (e.g., move to the end of a queue) the one or more frequency bands as part of the second band scan procedure for subscription 210-b (or subscription 210-a) based on a timer threshold being satisfied (e.g., at least a threshold amount of time has elapsed, at least a first threshold amount of time and less than a second threshold amount of time has elapsed). In some cases, UE 115-a may store a timestamp along with each indication of the one or more scanned frequency bands as part of the first band scan procedure, and UE 115-a may determine how much time has elapsed since an indication of a frequency band was stored.

In some additional or alternative cases, UE 115-a may determine the relevance of stored frequency band information based on location and/or movement. For example, UE 115-a may determine a geolocation based on a Global Positioning System (GPS) coordinate and/or a public land mobile network (PLMN). In some examples, UE 115-a may determine a mobility status based on a Tracking Area Code (TAC) and/or a number of cell changes. UE 115-a may scan a frequency band at a first location as part of the first band scan procedure, and UE 115-a may scan the same frequency band at a second location as part of the second band scan procedure. In some cases, UE 115-a may determine a higher relevance of the information stored from the first scan procedure based on the first location being the same as, or close to, the second procedure scan location. The UE 115-a may determine a lower relevance of the information stored from the first scan procedure based on the first location being different, or substantially different from, the second scan procedure location. Additionally, a time threshold or duration may be configured based on device mobility, which may further improve accuracy of the determined relevance. For example, highly mobile UEs may be configured with shorter time threshold or durations, while more stationary or static UEs may be configured with longer time thresholds or durations. Configuring fairly mobile UEs with shorter time thresholds and fairly stationary UEs with longer time thresholds may support UEs in scanning frequency bands that are likely to be associated with a frequency or PLMN, before scanning frequency bands that are less likely to be associated with frequency or PLMN, which may reduce redundant band scans and increase the speed at which the UE camps on a cell.

In some cases, UE 115-a may determine band relevance based on one or more techniques as described herein. For examples, using multiple techniques (e.g., a timer based technique and a location based technique) in conjunction to determine the relevance of the frequency bands (e.g., the saved frequency band scan results) may support UE 115-a in skipping or deprioritizing previously scanned frequency bands, which may decrease signal acquisition time and improve user experience.

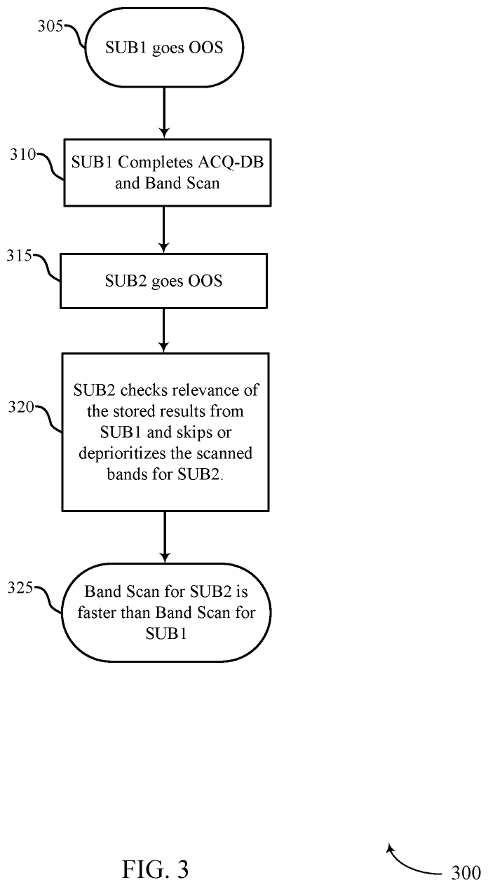

FIG. 3 illustrates an example of a flowchart 300 that supports radio frequency band scanning for multiple SIMS in accordance with aspects of the present disclosure. In some examples, the flowchart 300 may implement aspects of wireless communication system 100 or 200. A UE may be associated with multiple network subscriptions. For example, the UE may be associated with a first subscription (e.g., SUB1) corresponding to a first SIM (e.g., SIM1) and a second subscription (e.g., SUB2) corresponding to a second SIM (e.g., SIM2). In some cases, a subscription may correspond to a default data SIM (DDS), a non-DDS (nDDS), or the like.

At 305, the first subscription may go out of service (OOS). For example, the UE may leave the coverage area of a cell corresponding to the first subscription (e.g., SUB1), which may result in the first subscription (e.g., SUB1) going OOS.

At 310, the UE may complete an acquisition database (ACQ-DB) procedure and a first band scan procedure corresponding to the first subscription (e.g., SUB1). In some cases, the UE may perform the first band scan procedure based on not identifying a frequency (e.g., a PLMN, a synchronization signal block (SSB), a cell, etc.) as part of the ACQ-DB procedure. The UE may store an indication of the frequency bands stored as part of the first band scan procedure.

At 315, the second subscription (e.g., SUB2) may go OOS. For example, the UE may leave the coverage area of a cell corresponding to the second subscription (e.g., SUB2), which may result in the second subscription (e.g., SUB2) going OOS.

At 320, the UE may perform a second band scan procedure. In some cases, the second band scan procedure may be based on the first band scan procedure. For example, the UE may identify one or more scanned frequency bands for the second scan procedure based on storing results from the first band scan procedure. The UE may determine the relevance of the stored information from the first band scan procedure and skip or deprioritize one or more frequency bands in the second band scan procedure based on the determined relevance. For example, the UE may refrain from scanning (e.g., skip) frequency bands that were scanned as part of the band first band scan procedure if the stored information for those frequency bands has a relevance above a threshold. The UE may deprioritize (e.g., modify the scanning order such that unique bands are scanned before previously-scanned bands) frequency bands that were scanned as part of the first band scan procedure if the relevance of the stored information for those frequency bands is below a threshold. In some examples, the second band scan procedure may be performed by the SUB1, where SUB1 uses stored information from a first band scan procedure to determine a scanning order for the second band scan procedure.

At 325, the UE may complete the second band scan procedure. In some cases, the time taken to complete the second band scan procedure may be less than the time taken to complete the first band scan procedure, as the UE may utilize band scan information from the first band scan procedure (e.g., frequency bands that are associated with a frequency and/or SSB, frequency bands that are not associated with a frequency and/or SSB, etc.). Utilizing band scan information from one scanning procedure in another scanning procedure may improve network connection speed. For example, following a power up procedure, a UE may use the techniques described herein to quickly acquire service for an nDDS.

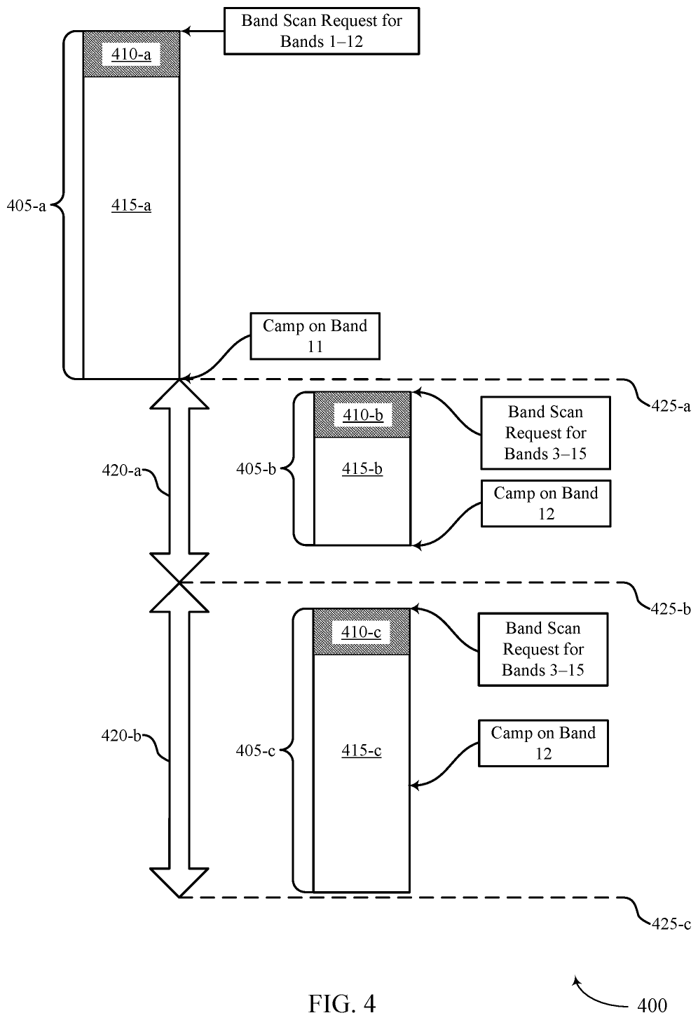

FIG. 4 illustrates an example of a band scan technique 400 that supports radio frequency band scanning for multiple SIMs in accordance with aspects of the present disclosure. In some examples, the band scan technique 400 may implement aspects of wireless communication system 100 or 200. A UE may utilize one or more techniques described in the band scan technique 400 to rapidly identify a frequency or SSB and camp on a cell.

In some cases, the UE may be perform a first band scan procedure for a first subscription (e.g., SUB 410-a, a first SIM) and a second band scan procedure for a second subscription (e.g., SUB 410-b, SUB 410-c, a second SIM). In some cases, the UE may be configured with one or more time thresholds (e.g., time threshold 425-a, time threshold 425-b, time threshold 425-c). The UE may use band scan information from the first band scan procedure to decrease signal acquisition time of the second band scan procedure.

As a non-limiting example, the UE may perform a first band scan procedure for a first subscription (e.g., SUB 405-a). The UE may not identify a valid frequency or SSB for the first subscription as part of frequency band scans using ACK-DB 410-a. The UE may perform scan procedure 415-a for frequency bands one through twelve of the first subscription. At 425-a, the UE may complete scan procedure 415-a and may start a timer. The UE may store an indication of frequency bands that were scanned as part of scan procedure 415-a. The UE may perform a second band scan procedure for a second subscription (e.g., SUB 405-b, a second SIM). The UE may not identify a valid frequency or SSB for the second subscription as part of frequency band scans using ACK-DB 410-b, and the UE may perform scan procedure 415-b for frequency bands three through fifteen of the second subscription (e.g., SUB 405-b). In some cases, the UE may determine the relevance of band scan information from scan procedure 415-a (e.g., the first band scan procedure) to scan procedure 415-b or to scan procedure 415-c (e.g., the second band scan procedure) based on one or more time indicators 425 (e.g., time thresholds 425).

In some cases, the second band scan procedure may be started during time duration 420-a (e.g., after 425-a, before 425-b, after 425-a and before 425-b, etc.), and the UE may skip frequency bands that are common to the first subscription (e.g., 405-a) and the second subscription (SUB 405-b). For example, the UE may skip frequency bands three through twelve (e.g., refrain from scanning) in the second band scan procedure (e.g., scan procedure 415-b) based on scanning bands three through twelve as part of the first scan procedure (e.g., scan procedure 415-a). The UE may camp on cell twelve based on the second band scan procedure (e.g., scan procedure 415-b).

In some additional or alternative cases, the second band scan procedure (e.g., scan procedure 415-c) may be started during time duration 420-b (e.g., before 425-c, after 425-b and before 425-c), and the UE may deprioritize frequency bands that are common to the first subscription (e.g., SUB 405-a) and the second subscription (e.g., SUB 405-b). For example, the UE may first scan frequency bands frequency bands unique to a second SIM (e.g., SUB 405-b or SUB 405-c) before scanning frequency bands common to a first SIM (e.g., SUB 405-a) and the second SIM. In some cases, the UE may restart the timer or start a new timer at time indicator 425-b (e.g., time threshold 425-b). The UE may camp on cell twelve based on the second band scan procedure (e.g., scan procedure 415-c). At 425-c, the UE may identify a timer expiration and delete the context of scanned bands. For example, the UE may delete (e.g., remove) the stored indications of scanned frequency bands.

The UE may store an indication of frequencies (e.g., an indication of global synchronization channel number (GSCNs)) detected for a first subscriber (e.g., SUB 405-a) in an ACK-DB, and the UE may scan the frequencies indicated in the ACK-DB when performing the band scan procedure for a second subscriber (e.g., SUB 405-b, SUB 405-c, etc.). Scanning the frequencies indicated in the ACK-DB may support the UE in scanning all detected frequencies that overlap the first subscriber and the second subscriber before performing a band scan procedure (e.g., scan procedure 415-b, scan procedure 415-c) for a subscription, which may prevent the UE from missing valid cells while performing band scan procedures.

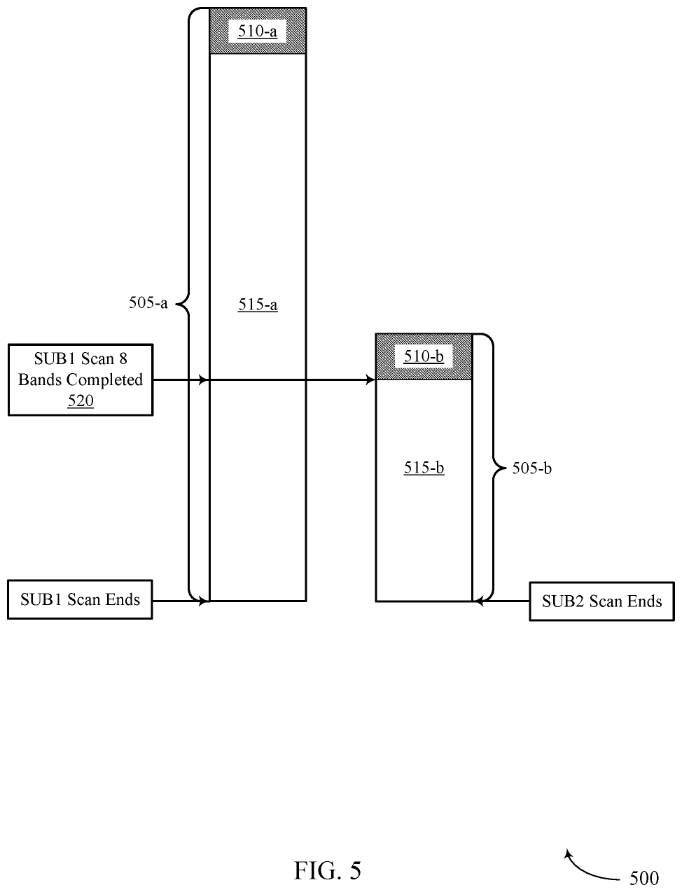

FIG. 5 illustrates an example of a band scan technique 500 that supports radio frequency band scanning for multiple SIMs in accordance with aspects of the present disclosure. In some examples, the band scan technique 500 may implement aspects of wireless communication system 100 or 200. A UE may utilize one or more techniques described in the band scan technique 500 as part of a band scan procedure, which may support the UE in rapidly camping on one or more cells.

In some cases, the UE may perform a band scan procedure for a first subscription (e.g., SUB 505-a) and a second subscription (e.g., SUB 505-b). The UE may use band scan information from the first band scan procedure to decrease signal acquisition time for the second band scan procedure. For example, the UE may determine a relevance or applicability of the band scan information from the first band scan procedure to the second band scan procedure. The UE may determine the relevance or applicability of the band scan information based on a time difference, a device mobility level, an operator corresponding to the first subscription or SIM, an operator corresponding to the second subscription or SIM, or any combination thereof.

As a non-limiting example, the UE may perform a first band scan procedure (e.g., a scan procedure 515-a) for a first subscription (e.g., SUB 505-a, a first SIM). The UE may not identify a valid cell for the first subscription as part of frequency band scans using ACK-DB 510-a, and the UE may not identify a valid cell for the second subscription (e.g., SUB 505-b, a second SIM) as part of frequency band scans using ACK-DB 510-b. At 520, the UE may complete scanning eight frequency bands (e.g., frequency bands 1 through 8) as part of scan procedure 515-a, and the UE may start scan procedure 515-b. In some cases, the UE may store an indication of the frequency bands scanned as part of scan procedure 515-a (e.g., an indication of frequency bands 1 through eight). The UE may leverage the information of the frequency bands scanned as part of scan procedure 515-a to improve the speed of scan procedure 515-b. For example, the UE may scan the last two frequency bands (e.g., frequency bands 9 and 10) of the second subscription (e.g., SUB 505-b). In some cases, the UE may complete scan procedures 515-a and 515-b at the same time, or nearly the same time. For example, the UE may camp on a first cell corresponding to the first subscription and a second cell corresponding to the second subscription, based on scan procedures 515-a and 515-b, respectively. It should be understood that the UE may scan all detected frequencies (e.g., detected cell, detected GSCNs) that are part of overlapping bands across the first subscription (e.g., SUB 505-a) and the second subscription (e.g., SUB 505-b) during frequency band scans corresponding to ACK-DB 510-b, so the UE may skip one or more overlapping bands while not skipping non-overlapping bands.

In some cases, the UE may implement one or more strategies described herein after powering up in a new area. For example, the UE may power up in an NR+NR mode (e.g., a dual-SIM mode, a multi-SIM mode). A DDS subscription (e.g., SUB 505-a) may come online first and no ACK-DB entries may be found (e.g., radiated), so the UE may perform a band scan procedure (e.g., scan procedure 515-a). An nDDS subscription (e.g., SUB 505-b) may come online a few seconds after the DDS subscription, and no ACK-DB entries may be found (e.g., radiated), so the UE may perform an additional band scan procedure (e.g., scan procedure 515-b). The UE may skip one or more bands while performing the additional band scan procedure (e.g., scan procedure 515-b) based on band scan information from the band scan procedure (e.g., scan procedure 515-a). In some examples, if scan procedure 515-a is ongoing, the nDDS subscription (e.g., SUB 505-b) may query the DDS subscription (e.g., SUB 515-a) to determine the band scan information (e.g., the bands that have already been scanned by the DDS subscription (e.g., SUB 505-a)). In some other examples, if scan procedure 515-a is not ongoing, a timer may be running, and the nDDS subscription (e.g., SUB 505-b) may use an indication of the scanned frequency bands to determine the band scan information (e.g., the bands that have already been scanned by the DDS subscription (e.g., SUB 505-a)).

In some cases, the UE may implement one or more strategies described herein after an RLF. In some examples, the UE may start a timer if any subscriptions have performed a band scan as part of a PLMN search or OOS scans. If a subscription experiences an RLF or an OOS status, and no valid cells are found in an ACK-DB, the UE may perform a band scan procedure for the subscription. In some cases, if the timer is running, the UE may skip frequency bands that are common to the subscription and another subscription while performing the band scan for the subscription. In some additional or alternative cases, if a different timer is running, or a threshold time condition has been satisfied (e.g., at least a certain amount of time has elapsed since starting the timer), the UE may deprioritize frequency bands that are common to the subscription and another subscription. There may be a higher chance of finding frequencies on the unique frequency bands instead of the common frequency bands, so prioritizing the unique frequency bands (e.g., deprioritizing the common bands) may reduce camping delay and improve user experience.

In some cases, the techniques described herein may yield significant power savings during power up scans in areas with no cell coverage or sparse cell coverage. With the advent of standalone NR operation, there may be a large number of supported bands per specification, and scanning all of the supported bands in an area without cell coverage may be time consuming, but the techniques described herein may reduce scanning time. In some additional or alternative cases, the UE may perform the techniques described herein on individual absolute radio-frequency channel numbers (ARFCNs) and/or subcarrier spacings (SCSs) instead of, or in addition to, complete frequency bands. Performing the techniques on ARFCNs and/or SCSs may reduce power usage and signal acquisition time in the context of partial scans.

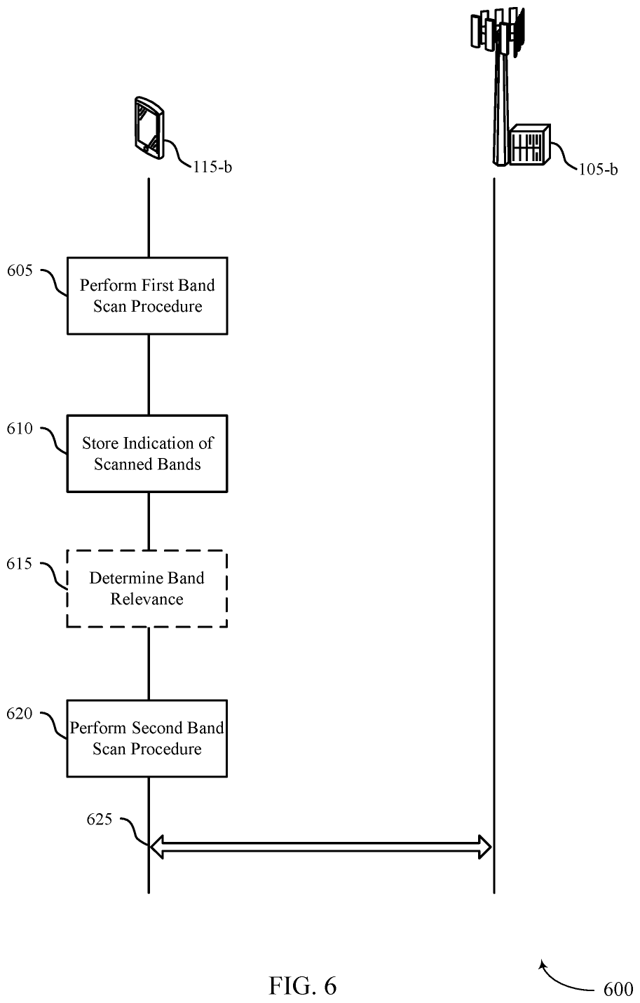

FIG. 6 illustrates an example of a process flow 600 that supports radio frequency band scanning for multiple SIMS in accordance with aspects of the present disclosure. In some examples, the process flow 600 may implement aspects of wireless communication system 100 or 200. The process flow 600 includes UE 115-b and base station 105-b, which may be examples of the corresponding devices described with reference to FIGS. 1 through 5. UE 115-b may split uplink data across links to improve battery life and decrease signal acquisition time. Alternative examples of the following may be implemented, where some steps are performed in a different order than described or are not performed at all. In some cases, steps may include additional features not mentioned below, or further steps may be added.

At 605, UE 115-b may perform a first band scan procedure for a first set of radio frequency bands according to a default scanning order at a first subscription. In some cases, the first subscription may correspond to an nDDS.

At 610, the UE may store an indication of a subset of radio frequency bands of the first set of radio frequency bands for the first scan procedure. In some cases, the subset of radio frequency bands may correspond to radio frequency bands that have been scanned as part of the first band scan procedure. In some additional or alternative cases, the subset of radio frequency bands may correspond to radio frequency bands that have been scanned without identifying a valid radio frequency band (e.g., a radio frequency band available for camping).

In some cases, the UE may determine a relevance of the stored indication of the subset of radio frequency bands at 615. In some examples, the UE may determine the relevance of the stored indication of the subset of radio frequency bands based on a time difference between the first scan procedure and the second scan procedure and/or a location of the first scan procedure and a location of the second scan procedure. In some cases, the UE may determine the modified scanning order based on the relevance of the stored indication. For example, the UE may determine whether to skip scanning some bands as part of the second scan procedure, deprioritize the scanning of some bands as part of the second scan procedure, or otherwise modify the scanning order based on the relevance of the stored information from the first scan procedure.

At 620, UE 115-b may perform a second band scan procedure for a second set of radio frequency bands according to a modified scanning order based on the stored indication of the subset of radio frequency resources. In some cases, the modified scanning order may be based on skipping one or more radio frequency bands of the second set of radio frequency bands, deprioritizing one or more radio frequency bands of the second set of radio frequency bands, or prioritizing one or more radio frequency bands of the second set of radio frequency bands.

At 625, UE 115-b may establish a connection with base station 105-b (e.g., camp on a cell), based on the first scan procedure, the second scan procedure or both.

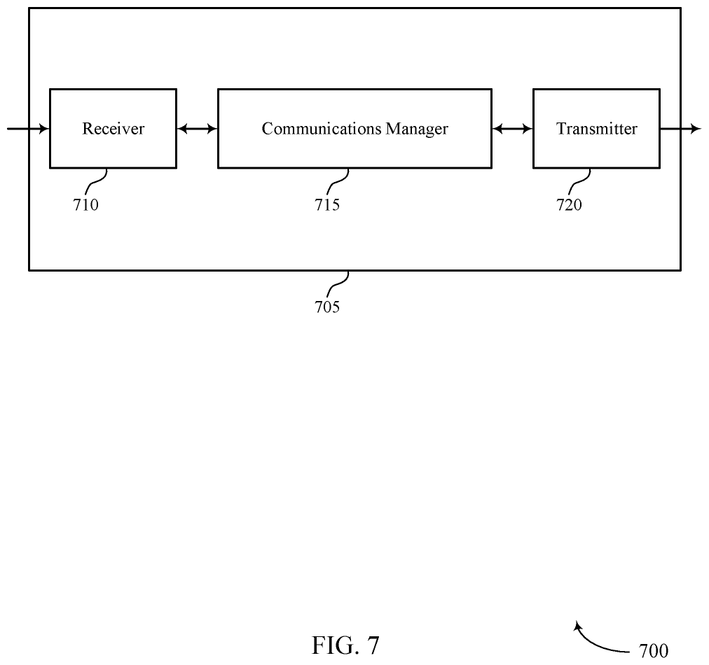

FIG. 7 shows a block diagram 700 of a device 705 that supports radio frequency band scanning for multiple SIMS in accordance with aspects of the present disclosure. The device 705 may be an example of aspects of a UE 115 as described herein. The device 705 may include a receiver 710, a communications manager 715, and a transmitter 720. The device 705 may also include a processor. Each of these components may be in communication with one another (e.g., via one or more buses).

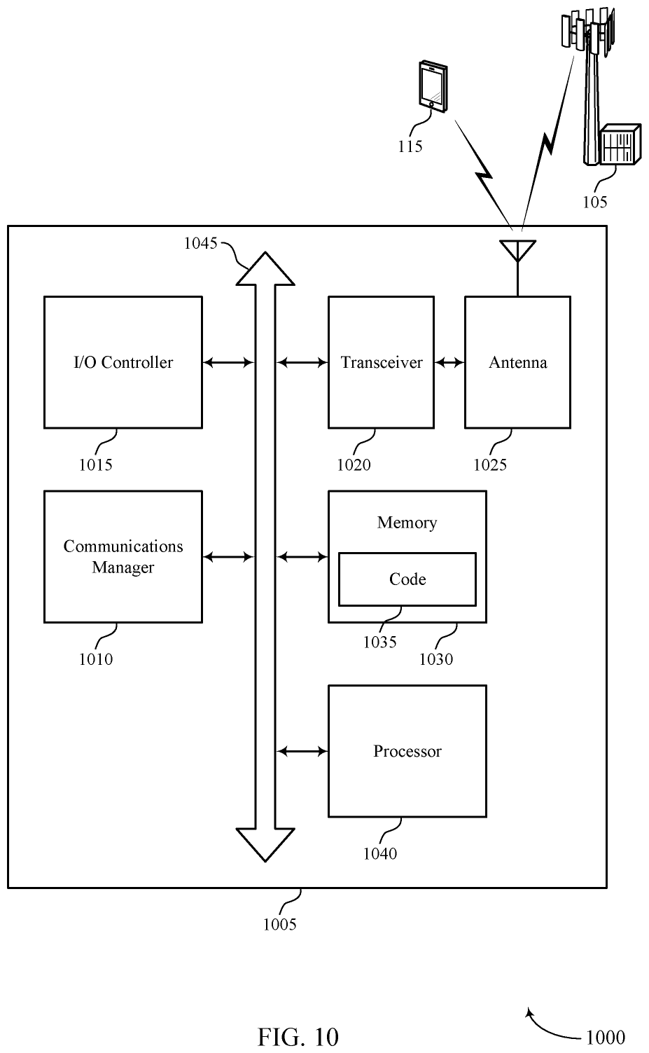

The receiver 710 may receive information such as packets, user data, or control information associated with various information channels (e.g., control channels, data channels, and information related to radio frequency band scanning for multiple SIMs, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may perform, at a first subscription of the UE, a first scan procedure for a first set of radio frequency bands according to a default scanning order, store an indication of a subset of radio frequency bands of the first set of radio frequency bands for the first scan procedure, and perform a second scan procedure for a second set of radio frequency bands according to a modified scanning order based on the stored indication of the subset of radio frequency bands. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

The actions performed by the communications manager 715, among other examples herein, may be implemented to realize one or more potential advantages. For example, communications manager 715 may increase available battery power, improve frequency band scanning efficiency, and reduce service acquisition time at a wireless device (e.g., a UE 115) by supporting frequency band scanning procedures for multiple SIMS. For example, the modified scanning order of the set of radio frequency resources, as described herein, may improve frequency band scanning efficiency by providing techniques for scanning frequency bands that are likely to be associated with a value frequency or SSB. The improvement in scanning efficiency may result in faster service acquisition and less power usage. Accordingly, communications manager 715 may save power and increase battery life at a wireless device (e.g., a UE 115) by improving the efficiency of frequency band scanning.

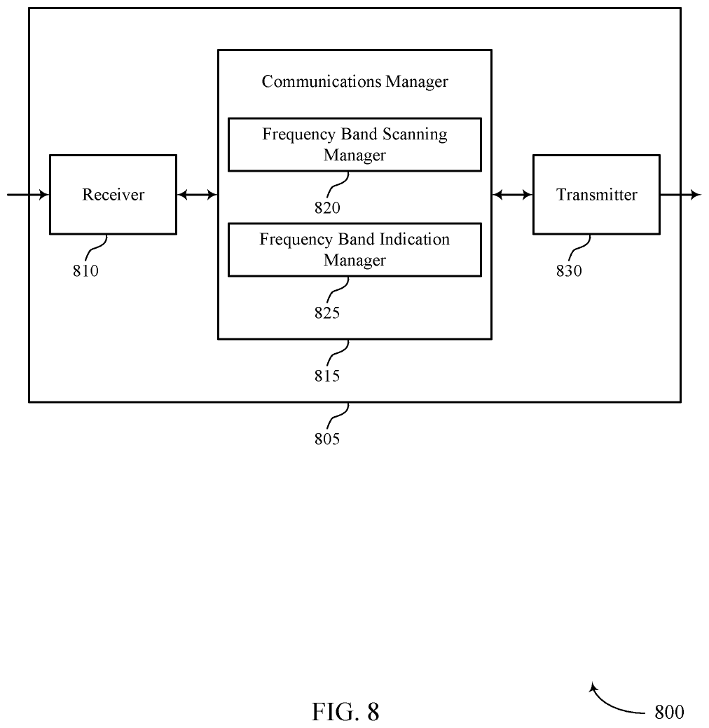

FIG. 8 shows a block diagram 800 of a device 805 that supports radio frequency band scanning for multiple SIMS in accordance with aspects of the present disclosure. The device 805 may be an example of aspects of a device 705, or a UE 115 as described herein. The device 805 may include a receiver 810, a communications manager 815, and a transmitter 830. The device 805 may also include a processor. Each of these components may be in communication with one another (e.g., via one or more buses).

The receiver 810 may receive information such as packets, user data, or control information associated with various information channels (e.g., control channels, data channels, and information related to radio frequency band scanning for multiple SIMs, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a frequency band scanning manager 820 and a frequency band indication manager 825. The communications manager 815 may be an example of aspects of the communications manager 1010 described herein.

The frequency band scanning manager 820 may perform, at a first subscription of the UE, a first scan procedure for a first set of radio frequency bands according to a default scanning order. The frequency band indication manager 825 may store an indication of a subset of radio frequency bands of the first set of radio frequency bands for the first scan procedure. The frequency band scanning manager 820 may perform a second scan procedure for a second set of radio frequency bands according to a modified scanning order based on the stored indication of the subset of radio frequency bands.

The transmitter 830 may transmit signals generated by other components of the device 805. In some examples, the transmitter 830 may be collocated with a receiver 810 in a transceiver module. For example, the transmitter 830 may be an example of aspects of the transceiver 1020 described with reference to FIG. 10. The transmitter 830 may utilize a single antenna or a set of antennas.

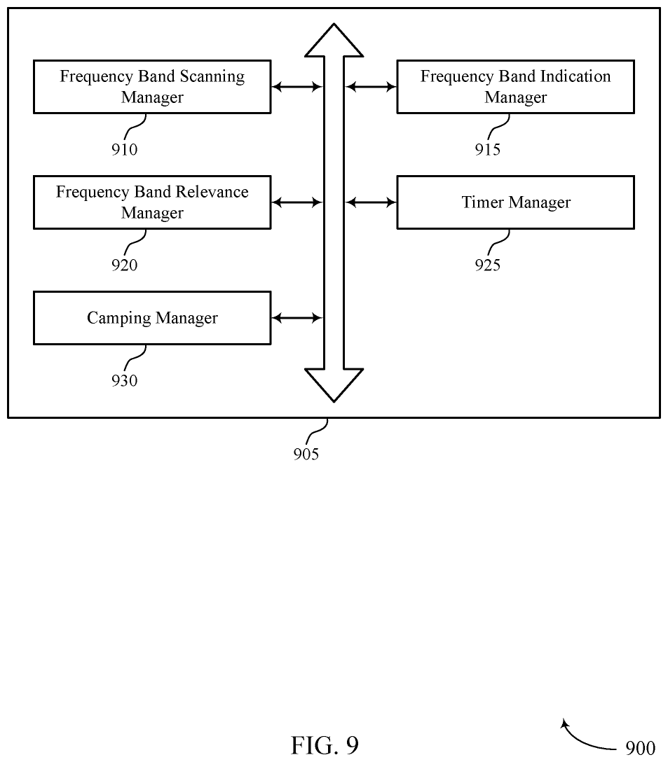

FIG. 9 shows a block diagram 900 of a communications manager 905 that supports radio frequency band scanning for multiple SIMs in accordance with aspects of the present disclosure. The communications manager 905 may be an example of aspects of a communications manager 715, a communications manager 815, or a communications manager 1010 described herein. The communications manager 905 may include a frequency band scanning manager 910, a frequency band indication manager 915, a frequency band relevance manager 920, a timer manager 925, and a camping manager 930. Each of these modules may communicate, directly or indirectly, with one another (e.g., via one or more buses).

The frequency band scanning manager 910 may perform, at a first subscription of the UE, a first scan procedure for a first set of radio frequency bands according to a default scanning order. The frequency band indication manager 915 may store an indication of a subset of radio frequency bands of the first set of radio frequency bands for the first scan procedure. In some examples, the frequency band scanning manager 910 may perform a second scan procedure for a second set of radio frequency bands according to a modified scanning order based on the stored indication of the subset of radio frequency bands.

In some examples, the frequency band scanning manager 910 may determine that the second scan procedure starts within a first time threshold from an end of the first scan procedure. In some examples, the frequency band scanning manager 910 may skip the subset of radio frequency bands of the first set of radio frequency bands based on the indication of the subset of radio frequency bands.

In some examples, the frequency band scanning manager 910 may determine that the second scan procedure starts within a second time threshold from an end of the first scan procedure. In some examples, the frequency band scanning manager 910 may determine the modified scanning order by prioritizing scanning of radio frequency bands of the second set of radio frequency bands that are different than the subset of radio frequency bands of the first set of radio frequency bands based on the indication of the subset of radio frequency bands.

In some examples, the frequency band scanning manager 910 may determine that the second scan procedure has completed based on satisfying a time threshold. In some examples, the frequency band scanning manager 910 may remove the indication of the subset of radio frequency bands of the first set of radio frequency bands based on determining that the second scan procedure has completed.

In some cases, the subset of radio frequency bands of the first set of radio frequency bands corresponds radio frequency bands scanned during the first scan procedure.

The frequency band relevance manager 920 may determine a relevance of the stored indication of the subset of radio frequency bands of the first set of radio frequency bands. In some examples, the frequency band relevance manager 920 may determine the modified scanning order based on the relevance of the stored indication.

In some examples, the frequency band relevance manager 920 may identify a time difference between the first scan procedure and the second scan procedure, a location of the first scan procedure and a location of the second scan procedure, or a combination thereof.

The timer manager 925 may configure a first timer length for a first timer and a second timer length for a second timer, where the first timer length is shorter than the second timer length. In some examples, the timer manager 925 may determine that the first timer is active. In some examples, the timer manager 925 may determine that the second timer is active. In some examples, the timer manager 925 may activate a first timer and performing the second scan procedure based on activating the first timer.

The camping manager 930 may camp on a first radio frequency of the first set of radio frequency bands based on the first scan procedure. In some examples, the camping manager 930 may camp on the first radio frequency of the second set of radio frequency bands based on the second scan procedure.

FIG. 10 shows a diagram of a system 1000 including a device 1005 that supports radio frequency band scanning for multiple SIMs in accordance with aspects of the present disclosure. The device 1005 may be an example of or include the components of device 705, device 805, or a UE 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may perform, at a first subscription of the UE, a first scan procedure for a first set of radio frequency bands according to a default scanning order, store an indication of a subset of radio frequency bands of the first set of radio frequency bands for the first scan procedure, and perform a second scan procedure for a second set of radio frequency bands according to a modified scanning order based on the stored indication of the subset of radio frequency bands.

By including or configuring the communications manager 1010 in accordance with examples as described herein, the device 1005 may support techniques for improved latency batter life, frequency band scanning efficiency, service acquisition time, power consumption, coordination between devices, and processing capability, among other benefits

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include random-access memory (RAM) and read-only memory (ROM). The memory 1030 may store computer-readable, computer-executable code 1035 including instructions that, when executed, cause the processor to perform various functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting radio frequency band scanning for multiple SIMs).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

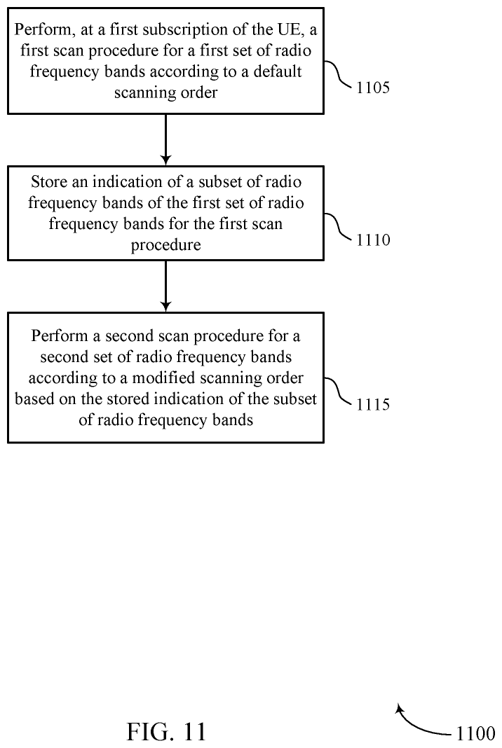

FIG. 11 shows a flowchart illustrating a method 1100 that supports radio frequency band scanning for multiple SIMs in accordance with aspects of the present disclosure. The operations of method 1100 may be implemented by a UE 115 or its components as described herein. For example, the operations of method 1100 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1105, the UE may perform, at a first subscription of the UE, a first scan procedure for a first set of radio frequency bands according to a default scanning order. The operations of 1105 may be performed according to the methods described herein. In some examples, aspects of the operations of 1105 may be performed by a frequency band scanning manager as described with reference to FIGS. 7 through 10.

At 1110, the UE may store an indication of a subset of radio frequency bands of the first set of radio frequency bands for the first scan procedure. The operations of 1110 may be performed according to the methods described herein. In some examples, aspects of the operations of 1110 may be performed by a frequency band indication manager as described with reference to FIGS. 7 through 10.

At 1115, the UE may perform a second scan procedure for a second set of radio frequency bands according to a modified scanning order based on the stored indication of the subset of radio frequency bands. The operations of 1115 may be performed according to the methods described herein. In some examples, aspects of the operations of 1115 may be performed by a frequency band scanning manager as described with reference to FIGS. 7 through 10.

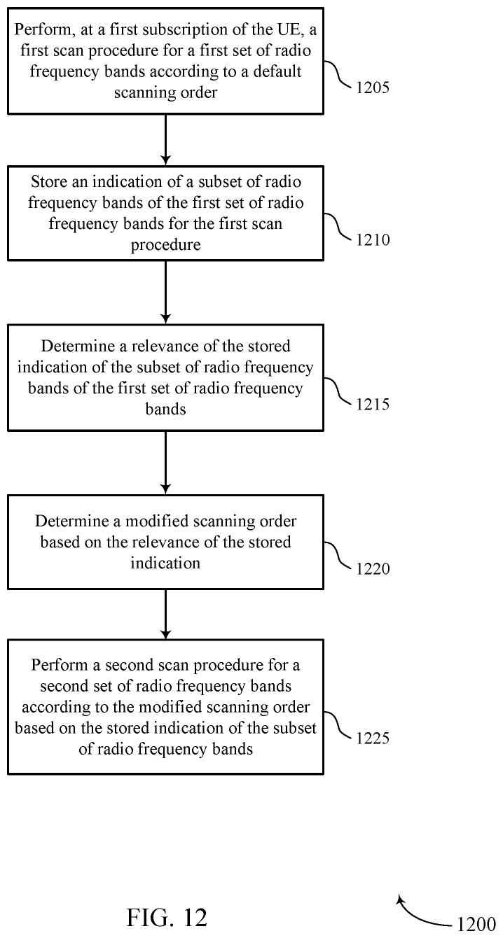

FIG. 12 shows a flowchart illustrating a method 1200 that supports radio frequency band scanning for multiple SIMs in accordance with aspects of the present disclosure. The operations of method 1200 may be implemented by a UE 115 or its components as described herein. For example, the operations of method 1200 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1205, the UE may perform, at a first subscription of the UE, a first scan procedure for a first set of radio frequency bands according to a default scanning order. The operations of 1205 may be performed according to the methods described herein. In some examples, aspects of the operations of 1205 may be performed by a frequency band scanning manager as described with reference to FIGS. 7 through 10.

At 1210, the UE may store an indication of a subset of radio frequency bands of the first set of radio frequency bands for the first scan procedure. The operations of 1210 may be performed according to the methods described herein. In some examples, aspects of the operations of 1210 may be performed by a frequency band indication manager as described with reference to FIGS. 7 through 10.

At 1215, the UE may determine a relevance of the stored indication of the subset of radio frequency bands of the first set of radio frequency bands. The operations of 1215 may be performed according to the methods described herein. In some examples, aspects of the operations of 1215 may be performed by a frequency band relevance manager as described with reference to FIGS. 7 through 10.

At 1220, the UE may determine a modified scanning order based on the relevance of the stored indication. The operations of 1220 may be performed according to the methods described herein. In some examples, aspects of the operations of 1220 may be performed by a frequency band relevance manager as described with reference to FIGS. 7 through 10.

At 1225, the UE may perform a second scan procedure for a second set of radio frequency bands according to the modified scanning order based on the stored indication of the subset of radio frequency bands. The operations of 1225 may be performed according to the methods described herein. In some examples, aspects of the operations of 1225 may be performed by a frequency band scanning manager as described with reference to FIGS. 7 through 10.

The following provides an overview of aspects of the present disclosure:
Aspect 1: A method for wireless communication at a UE, comprising: performing, at a first subscription of the UE, a first scan procedure for a first set of radio frequency bands according to a default scanning order; storing an indication of a subset of radio frequency bands of the first set of radio frequency bands for the first scan procedure; and performing a second scan procedure for a second set of radio frequency bands according to a modified scanning order based at least in part on the stored indication of the subset of radio frequency bands.
Aspect 2: The method of aspect 1, wherein performing the second scan procedure comprises: determining a relevance of the stored indication of the subset of radio frequency bands of the first set of radio frequency bands; and determining the modified scanning order based at least in part on the relevance of the stored indication.
Aspect 3: The method of aspect 2, wherein determining the relevance of the stored indication of the subset of radio frequency bands of the first set of radio frequency bands comprises: identifying a time difference between the first scan procedure and the second scan procedure, a location of the first scan procedure and a location of the second scan procedure, or a combination thereof.
Aspect 4: The method of any of aspects 1 through 3, wherein performing the second scan procedure comprises: determining that the second scan procedure starts within a first time threshold from an end of the first scan procedure; and skipping the subset of radio frequency bands of the first set of radio frequency bands based at least in part on the indication of the subset of radio frequency bands.
Aspect 5: The method of any of aspects 1 through 4, wherein performing the second scan procedure comprises: determining that the second scan procedure starts within a second time threshold from an end of the first scan procedure; and determining the modified scanning order by prioritizing scanning of radio frequency bands of the second set of radio frequency bands that are different than the subset of radio frequency bands of the first set of radio frequency bands based at least in part on the indication of the subset of radio frequency bands.
Aspect 6: The method of aspect 5, further comprising: configuring a first timer length for a first timer and a second timer length for a second timer, wherein the first timer length is shorter than the second timer length.
Aspect 7: The method of aspect 6, wherein determining that the second scan procedure starts within a first time threshold comprises: determining that the first timer is active.
Aspect 8: The method of any of aspects 6 through 7, wherein determining that the second scan procedure starts within the second time threshold comprises: determining that the second timer is active.
Aspect 9: The method of any of aspects 1 through 8, further comprising: activating a first timer and performing the second scan procedure based at least in part on activating the first timer.
Aspect 10: The method of any of aspects 1 through 9, wherein the subset of radio frequency bands of the first set of radio frequency bands corresponds radio frequency bands scanned during the first scan procedure.
Aspect 11: The method of any of aspects 1 through 10, further comprising: camping on a first radio frequency of the first set of radio frequency bands based at least in part on the first scan procedure; and camping on the first radio frequency of the second set of radio frequency bands based at least in part on the second scan procedure.
Aspect 12: The method of any of aspects 1 through 11, further comprising: determining that the second scan procedure has completed based at least in part on satisfying a time threshold; and removing the indication of the subset of radio frequency bands of the first set of radio frequency bands based at least in part on determining that the second scan procedure has completed.
Aspect 13: An apparatus for wireless communication at a UE, comprising a processor; memory coupled with the processor; and instructions stored in the memory and executable by the processor to cause the apparatus to perform a method of any of aspects 1 through 12.
Aspect 14: An apparatus for wireless communication at a UE, comprising at least one means for performing a method of any of aspects 1 through 12.
Aspect 15: A non-transitory computer-readable medium storing code for wireless communication at a UE, the code comprising instructions executable by a processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
performing, at a first subscription of the UE, a first scan procedure for a first set of radio frequency bands according to a default scanning order;
storing an indication of a subset of radio frequency bands of the first set of radio frequency bands for the first scan procedure; and
performing a second scan procedure for a second set of radio frequency bands according to a modified scanning order based at least in part on the stored indication of the subset of radio frequency bands.

2. The method of claim 1, wherein performing the second scan procedure comprises:
determining a relevance of the stored indication of the subset of radio frequency bands of the first set of radio frequency bands; and
determining the modified scanning order based at least in part on the relevance of the stored indication.

3. The method of claim 2, wherein determining the relevance of the stored indication of the subset of radio frequency bands of the first set of radio frequency bands comprises:
identifying a time difference between the first scan procedure and the second scan procedure, a location of the first scan procedure and a location of the second scan procedure, or a combination thereof.

4. The method of claim 1, wherein performing the second scan procedure comprises:
determining that the second scan procedure starts within a first time threshold from an end of the first scan procedure; and
skipping the subset of radio frequency bands of the first set of radio frequency bands based at least in part on the indication of the subset of radio frequency bands.

5. The method of claim 1, wherein performing the second scan procedure comprises:
determining that the second scan procedure starts within a second time threshold from an end of the first scan procedure; and
determining the modified scanning order by prioritizing scanning of radio frequency bands of the second set of radio frequency bands that are different than the subset of radio frequency bands of the first set of radio frequency bands based at least in part on the indication of the subset of radio frequency bands.

6. The method of claim 5, further comprising:
configuring a first timer length for a first timer and a second timer length for a second timer, wherein the first timer length is shorter than the second timer length.

7. The method of claim 6, wherein determining that the second scan procedure starts within a first time threshold comprises:
determining that the first timer is active.

8. The method of claim 6, wherein determining that the second scan procedure starts within the second time threshold comprises:
determining that the second timer is active.

9. The method of claim 1, further comprising:
activating a first timer and performing the second scan procedure based at least in part on activating the first timer.

10. The method of claim 1, wherein the subset of radio frequency bands of the first set of radio frequency bands corresponds radio frequency bands scanned during the first scan procedure.

11. The method of claim 1, further comprising:
camping on a first radio frequency of the first set of radio frequency bands based at least in part on the first scan procedure; and
camping on the first radio frequency of the second set of radio frequency bands based at least in part on the second scan procedure.

12. The method of claim 1, further comprising:
determining that the second scan procedure has completed based at least in part on satisfying a time threshold; and
removing the indication of the subset of radio frequency bands of the first set of radio frequency bands based at least in part on determining that the second scan procedure has completed.

13. An apparatus for wireless communication at a user equipment (UE), comprising:
a processor,
memory coupled with the processor; and
instructions stored in the memory and executable by the processor to cause the apparatus to:
perform, at a first subscription of the UE, a first scan procedure for a first set of radio frequency bands according to a default scanning order;
store an indication of a subset of radio frequency bands of the first set of radio frequency bands for the first scan procedure; and
perform a second scan procedure for a second set of radio frequency bands according to a modified scanning order based at least in part on the stored indication of the subset of radio frequency bands.

14. The apparatus of claim 13, wherein the instructions to perform the second scan procedure are executable by the processor to cause the apparatus to:
determine a relevance of the stored indication of the subset of radio frequency bands of the first set of radio frequency bands; and
determine the modified scanning order based at least in part on the relevance of the stored indication.

15. The apparatus of claim 14, wherein the instructions to determine the relevance of the stored indication of the subset of radio frequency bands of the first set of radio frequency bands are executable by the processor to cause the apparatus to:
identify a time difference between the first scan procedure and the second scan procedure, a location of the first scan procedure and a location of the second scan procedure, or a combination thereof.

16. The apparatus of claim 13, wherein the instructions to perform the second scan procedure are executable by the processor to cause the apparatus to:
determine that the second scan procedure starts within a first time threshold from an end of the first scan procedure; and
skip the subset of radio frequency bands of the first set of radio frequency bands based at least in part on the indication of the subset of radio frequency bands.

17. The apparatus of claim 13, wherein the instructions to perform the second scan procedure are executable by the processor to cause the apparatus to:
determine that the second scan procedure starts within a second time threshold from an end of the first scan procedure; and
determine the modified scanning order by prioritizing scanning of radio frequency bands of the second set of radio frequency bands that are different than the subset of radio frequency bands of the first set of radio frequency bands based at least in part on the indication of the subset of radio frequency bands.

18. The apparatus of claim 17, wherein the instructions are further executable by the processor to cause the apparatus to:
configure a first timer length for a first timer and a second timer length for a second timer, wherein the first timer length is shorter than the second timer length.

19. The apparatus of claim 18, wherein the instructions to determine that the second scan procedure starts within a first time threshold are executable by the processor to cause the apparatus to:
determine that the first timer is active.

20. The apparatus of claim 18, wherein the instructions to determine that the second scan procedure starts within the second time threshold are executable by the processor to cause the apparatus to:
determine that the second timer is active.

21. The apparatus of claim 13, wherein the instructions are further executable by the processor to cause the apparatus to:
activate a first timer and performing the second scan procedure based at least in part on activating the first timer.

22. The apparatus of claim 13, wherein the subset of radio frequency bands of the first set of radio frequency bands corresponds radio frequency bands scanned during the first scan procedure.

23. The apparatus of claim 13, wherein the instructions are further executable by the processor to cause the apparatus to:
camp on a first radio frequency of the first set of radio frequency bands based at least in part on the first scan procedure; and
camp on the first radio frequency of the second set of radio frequency bands based at least in part on the second scan procedure.

24. The apparatus of claim 13, wherein the instructions are further executable by the processor to cause the apparatus to:
determine that the second scan procedure has completed based at least in part on satisfying a time threshold; and
remove the indication of the subset of radio frequency bands of the first set of radio frequency bands based at least in part on determining that the second scan procedure has completed.

25. An apparatus for wireless communication at a user equipment (UE), comprising:
means for performing, at a first subscription of the UE, a first scan procedure for a first set of radio frequency bands according to a default scanning order;
means for storing an indication of a subset of radio frequency bands of the first set of radio frequency bands for the first scan procedure; and
means for performing a second scan procedure for a second set of radio frequency bands according to a modified scanning order based at least in part on the stored indication of the subset of radio frequency bands.

26. The apparatus of claim 25, wherein the means for performing the second scan procedure comprises:
means for determining a relevance of the stored indication of the subset of radio frequency bands of the first set of radio frequency bands; and
means for determining the modified scanning order based at least in part on the relevance of the stored indication.

27. The apparatus of claim 26, wherein the means for determining the relevance of the stored indication of the subset of radio frequency bands of the first set of radio frequency bands comprises:
means for identifying a time difference between the first scan procedure and the second scan procedure, a location of the first scan procedure and a location of the second scan procedure, or a combination thereof.

28. A non-transitory computer-readable medium storing code for wireless communication at a user equipment (UE), the code comprising instructions executable by a processor to:
perform, at a first subscription of the UE, a first scan procedure for a first set of radio frequency bands according to a default scanning order;
store an indication of a subset of radio frequency bands of the first set of radio frequency bands for the first scan procedure; and
perform a second scan procedure for a second set of radio frequency bands according to a modified scanning order based at least in part on the stored indication of the subset of radio frequency bands.

29. The non-transitory computer-readable medium of claim 28, wherein the instructions to perform the second scan procedure are executable to:
determine a relevance of the stored indication of the subset of radio frequency bands of the first set of radio frequency bands; and
determine the modified scanning order based at least in part on the relevance of the stored indication.

30. The non-transitory computer-readable medium of claim 29, wherein the instructions to determine the relevance of the stored indication of the subset of radio frequency bands of the first set of radio frequency bands are executable to:
identify a time difference between the first scan procedure and the second scan procedure, a location of the first scan procedure and a location of the second scan procedure, or a combination thereof.
